(19) United States
(12) Patent Application Publication
(10) Pub. No.: US 2010/0289760 A1
(43) Pub. Date: Nov. 18, 2010

(54) ELECTRONIC APPARATUS

(75) Inventors: Yasuhiro Jonoshita, Yokohama-shi (JP); Masanori Morobishi, Yokohama-shi (JP); Takeshi Yamane, Yokohama-shi (JP); Kazuya Chito, Yokohama-shi (JP); Yuji Kakuda, Yokohama-shi (JP); Masahiro Baba, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/678,131

(22) PCT Filed: Sep. 10, 2008
(86) PCT No.: PCT/JP2008/066290

§ 371 Date: Jul. 16, 2010

(30) Foreign Application Priority Data
Sep. 14, 2007 (JP) 2007-240189

(51) Int. Cl. G06F 3/041; G06F 3/048

(52) U.S. Cl. 345/173; 715/772

(57) ABSTRACT

The electronic apparatus according to the present invention comprises a first display unit 20 placed on one surface of a housing, a second display unit placed on the other surface opposite to said first display unit and provided with approximately the same display area as that of said first display unit 22, a touch panel 30 overlapped at least with one of said first and second display units 20 and 22, a control unit 100 for executing tasks, displaying images on said first or second display unit 20 or 22 and receiving input from said touch panel 30.

### BACKGROUND OF THE INVENTION

The present invention relates to an electronic apparatus which displays a task-executing screen using a display unit.

In recent years, electronic apparatuses represented by mobile phones, PHS (Personal Handy Phone System) or PDA (Personal Digital Assistant) are becoming smaller, lighter and functionally more advanced. As a result, they are used not only for a communication tool such as a phone or email sender, but also for a computer-like tool such as a camera, an audio player and a television.

The functionally more advanced an electronic apparatus becomes, the more a wide display area of the apparatus is demanded in order to carry out various tasks (applications) comfortably. However, since a demand for a wider display conflicts with that for a smaller body of an electronic apparatus, the area for an operation unit is decreased because of a wider display. So, it is usual that a number of functions are assigned to the same operation key or classified into a multi-level menu. It makes a user operate the apparatus in an unclear or troublesome manner.

In order to solve such a problem, Patent Document 1 (Japan Laid Open Patent 2007-079157) discloses an image display apparatus provided with two displays (liquid crystal displays) which may open and close. When the two displays open, they are adjacent and work together. Therefore, the apparatus achieves both of a wide display area and a small size of the apparatus itself. On the other hand, Patent Document 2 (Japan Laid Open Patent 2007-141029) discloses an apparatus provided with a first touch sensor on the surface of a display (information display), and with a second touch sensor on the opposite surface. The second touch sensor is used for a supplementary input means which recognizes a fingerprint.

Patent Document 1: Japan Laid Open Patent 2007-079157

Patent Document 2: Japan Laid Open Patent 2007-141029

According to Patent Document 1, the task-executing screen can be wider for the size of apparatus in a stored status. However, it is just because the display area is increased. According to Patent Document 2, the input means is placed on the rear surface of the apparatus which has not been used conventionally. However, it is just an improvement of operability by using the input means on the rear surface as an assistant of that on the front surface. So, both of Patent Documents cannot supply a sufficient operability of an electronic apparatus for its various functions caused by its advanced functions.

The object of the present invention is to provide an electronic apparatus with an improved operability.

In order to solve the above stated problems, according to an aspect of the present invention, an electronic apparatus comprises: a first display unit placed on one surface of a housing; a second display unit placed on the other surface opposite to said first display unit and provided with approximately the same display area as that of said first display unit; a touch panel overlapped at least with one of said first and second display units; a control unit for executing tasks, displaying images on said first or second display unit and receiving input from said touch panel.

Contours of said first and second display units may be curved and connected to each other in order to surround the periphery of the housing.

The contour of the housing may have an approximate elliptic form including said curved first and second display units.

Said control unit may display on said first display unit a screen of a task being executed, and displays on said second display unit a list screen of other tasks.

Said control unit may display on said first display unit a screen of a task being executed, and displays on said second display unit a list screen of several tasks including the task being executed.

Said control unit may sense that a specific area of said touch panel is rubbed, replace a task displayed on said first display unit with another new task which has been listed at the other end of the rubbing direction in the list screen on said second display unit, remove the new task displayed on said first display unit from the list screen on said second display unit, and add the task which has been displayed on said first display unit to the list screen on said second display unit at the end of the rubbing direction.

Said control unit may carry out an executing screen switch caused by the task switch by a continuous scroll display.

Said control unit can execute several tasks at the same time, may display executing screens of the executed several tasks on said first display unit so that an executing screen of a mainly executed task is displayed at the center in the rubbing direction and schematic executing screens of the other tasks are displayed at the upper or lower end in the rubbing direction.

Said control unit may enter into the rest status for stopping executing tasks except for predetermined tasks when no input from said touch panel is sensed for a predetermined time, return from the rest status when it is sensed that a specific area of said touch panel overlapped respectively with said first and second display units is touched for a predetermined time, and display a screen of a task being executed on the display unit which is on the same surface as the specific area being touched. For example, when no operation is sensed for a predetermined time, said control unit may enter into the rest status. When a specific area of said touch panel overlapped respectively with both surfaces of the housing is touched for a predetermined time, said control unit may return from the rest status. Said control unit uses the display unit on the same surface as the specific area being touched, as said first display unit.

The electronic apparatus may further comprise illumination sensors arranged on the both surfaces on which said first and second display units are respectively placed, wherein said control unit may compare outputs from said illumination sensors and display a screen of a task being executed on one of said display units placed on the surface from which a lighter illuminance is sensed. For example, said illumination sensors may be provided on the respective surfaces on which said first and second display units are placed. Said control unit may decide that one display unit positioned on a surface of higher illuminance is said first display unit, and that the other display unit placed on a surface of lower illuminance is said second display unit.

The electronic apparatus may further comprise a position difference sensor for sensing a position of the housing, wherein said control unit may display a screen of a task being executed on one of said first and second display units, based on a sensing result of said position difference sensor. For example, the electronic apparatus may comprise a position difference sensor for sensing a position of the housing. The control unit may decide that one display unit arranged on the surface directed upward is said first display unit, and that the other display unit arranged on the surface directed downward is said second display unit.

Said control unit may accept an input from one touch panel overlapped with one of said first and second display units on which a screen of a task being executed is displayed, and may not accept an input from the other touch panel overlapped with the other one of said display units. For example, said control unit may not accept an input from the touch panel overlapped with said second display unit, when it decides that one of said two display units is said first display unit.

The electronic apparatus may further comprise: an audio input unit arranged at one side of the housing; and an audio output unit arranged on the other side of the housing opposite to the one side on which said audio input unit is arranged.

### EFFECTS OF THE INVENTION

According to the present invention, the operability of an electronic apparatus can be improved.

### BRIEF EXPLANATION OF THE DRAWINGS

FIG. 1 is six orthogonal views for illustrating the appearance of a mobile phone.

FIG. 2 is a block diagram for illustrating schematic functions of the mobile phone.

FIG. 3 is a view for illustrating exemplified displays of the first and second display units.

FIG. 4 is a view for illustrating the relationship between the task-executing screen of the first display unit and the list screen of the second display unit.

FIG. 5 is a view for illustrating an exemplified manner to input task-switching using the touch panel.

FIG. 6 is a view of an exemplified screen of the first display unit displaying several task-executing screens.

FIG. 7 is a view for an exemplified method for making a decision on whether or not return from the rest status should be carried out using the touch panel.

FIG. 8 is a view for illustrating an exemplified structure of a mobile phone without a distinction between front and rear surfaces of a housing.

### EXPLANATION OF REFERENCE NUMERALS

10, 50 mobile phone
14 end member
16 end member
20 first display unit
22 second display unit
30 touch panel
30a and 30b task switch area
30c return decision area
32 second touch panel
40 camera
42 audio output unit
44 audio input unit
46 power button
48 stereo speaker
48a, 48b, 48c, 48d speaker hole
100 control unit
102 radio communication unit
104 memory
106 position difference sensor
200 base station

### BEST MODE FOR CARRYING OUT THE INVENTION

### First Embodiment

A mobile phone will be explained in detail below as a first embodiment of an electronic apparatus according to the present invention. In the following embodiments and drawings, the structural elements which have essentially the same functional structure are indicated by the same reference numerals in order to omit overlapping explanations. Sizes, materials and specific values of the following embodiments are no more than examples for making the present invention understood easily. Those matters do not restrict the scope of the present invention, unless it is distinctively described that they do so.

### Appearance

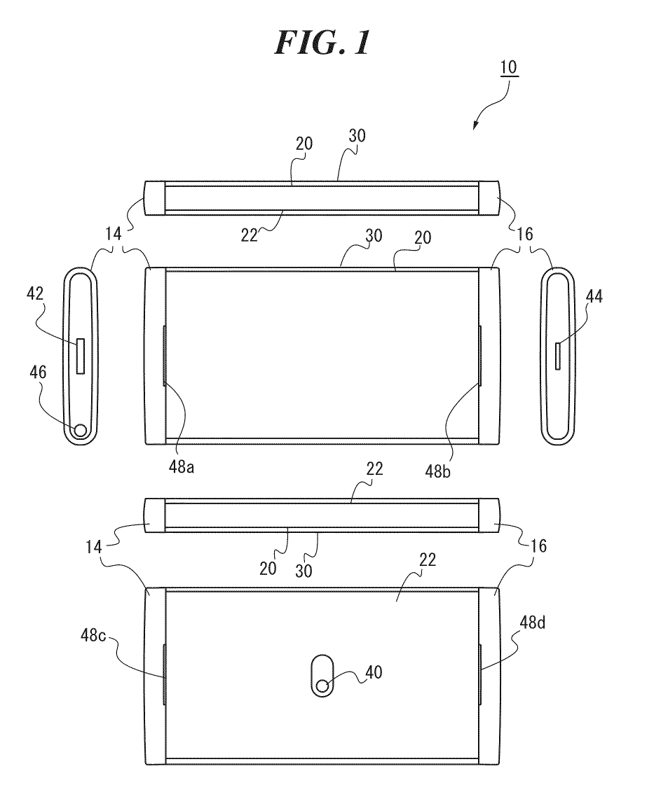

FIG. 1 is six orthogonal views for illustrating the appearance of the mobile phone. The mobile phone 10 shown in FIG. 1 comprises a first display unit 20 placed on one surface of the housing and a second display unit 22 placed on the other surface opposite to the first display unit 20 and provided with approximately the same display area as that of the first display unit 20. In the present embodiment, the first and second display units 20 and 22 are placed respectively on the front and rear surfaces of the mobile phone. On the first display unit 20, a transparent touch panel 30 is overlapped. At the center of the second display unit 22, a camera 40 is provided.

The first and second display units 20 and 22 are curved along their longitudinal direction. They are connected to each other in order to surround the periphery of the housing. The contour of the housing (on the front surface the touch panel 30 defines the contour) has an approximate elliptic form including the curved first and second display units 20 and 22. In other words, the first and second display units 20 and 22 form a flat tube-like form as a whole. At the both ends of the flat tube-like housing, end members 14 and 16 are provided.

The approximate elliptic form means not only a regular ellipse (including a circle) but also forms other than the regular ellipse. It includes any shape with round ends as a whole. For example, the approximate elliptic form of the present invention includes an oval shape with plane main surfaces and half-circle ends, another oval shape with convex main surfaces, and a modified ellipse which is compressed along the minor or major axis thereof.

At the end of the end member 14 placed at one side of the housing, an audio output unit 42 and a power button 46 are arranged. At the end of the end member 16 placed at the other side of the housing opposite to the audio output unit 42, an audio input unit 44 is arranged. By arranging the audio output unit 42 and the audio input unit 44 respectively at the ends of the end members 14 and 16 (both sides of the housing) as above, a user can grasp the housing regardless of rear or front surface of the housing when talking on the phone.

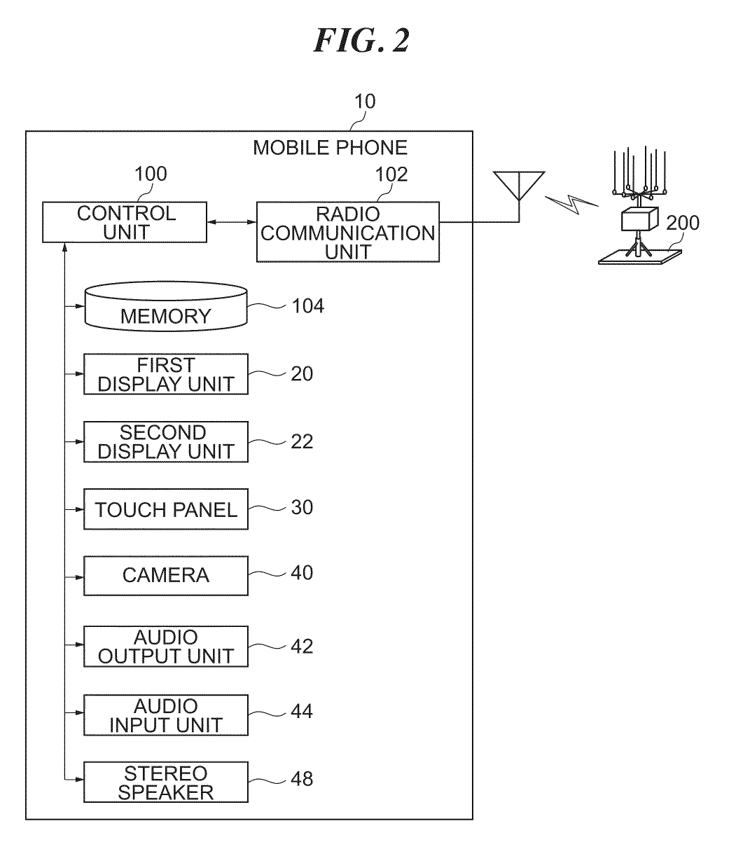

Speaker holes 48a and 48b are formed respectively in the regions between the first display unit 20 and the end members 14 and 16, at the central parts of shorter length of the housing. The holes 48a and 48b output the sound from inside to outside of the housing. Inside of the housing, stereo speakers 48 outputs the sound (see FIG. 2).

Similarly, speaker holes 48c and 48d are formed respectively in the regions between the second display unit 22 and the end members 14 and 16, at the central parts of shorter length of the housing. The holes 48c and 48d output the sound from inside to outside of the housing, too.

In the present embodiment, a stereo speaker 48 outputs sound from both of the speaker holes 48a and 48c. Similarly, another stereo speaker 48 outputs sound from both of the speaker holes 48b and 48d.

In the present embodiment, there are the two stereo speakers 48, one of them is placed at the side of the speaker holes 48a and 48c, the other one of them is placed at the side of the speaker holes 48b and 48d.

The stereo speakers 48 of the present embodiment are respectively directed outward along longer length of the housing, in order to output sound to both sides of the first and second display units 20 and 22 equally. There may be additionally a sound-conducting way which leads sound output from each stereo speaker 48 to the speaker holes 48a and 48c or 48b and 48d, in order to output sound to both sides of the first and second display units 20 and 22 equally.

### Functional Structure

FIG. 2 is a block diagram for illustrating schematic functions of the mobile phone. As shown in FIG. 2, in addition to the above stated first and second display units 20 and 22, touch panel 30, audio output unit 42, audio input unit 44 and stereo speakers 48, the mobile phone comprises at least a control unit 100, a radio communication unit 102 and a memory 104.

The control unit 100 is made of semiconductor integrated circuits including a Central Processing Unit (CPU). The control unit 100 manages and controls the whole mobile phone 10. The control unit 100 executes tasks (applications) stored in the memory 104, displays images on the first and second display units 20 and 22, and receives input from the touch panel 30. In this way, the control unit 100 uses programs stored in the memory 104 to execute various tasks executed on the mobile phone 10, such as a phone call function, a character inputting function, a sound player function, a TV viewer function etc.

The memory 104 can be comprised of ROM, RAM, E2PROM, non-volatile RAM, a flash memory and HDD and stores programs and data files processed by the control unit 100.

The first and second display units 20 and 22 may be a curved display or a display which can be curved. For example, they may be made of a TFT liquid Crystal Display (Thin Film Transistor Liquid Crystal Display) wherein transistors are formed on a plastic circuit board, an organic Electro Luminescence Display or a Cholesteric Liquid Crystal Display etc. In the present embodiment, TFT liquid crystal displays are used for the first and second display units 20 and 22, for example. It is possible to display on the first and second display units 20 and 22 an executing screen of a task, such as a Web browser or a scheduler, stored in the memory 104 in the mobile phone 10 or supplied via communication network from an application relay server (not shown in the drawings). By combining the first and second display units 20 and 22 with the touch panel 30 to be described later, it is also possible to form an input interface. Such an input interface has functions corresponding to those of conventional operation keys, such as a keyboard, cross-arranged keys or a joystick.

The touch panel 30 is made of a transparent or semitransparent material. The touch panel 30 is overlapped with the first display unit 20 so that the unit 20 is visible. Specifically, the touch panel 30 may be a so-called touch display attached to the front side of the display unit or a pressure sensor for sensing a pressure attached to the rear side of the display unit. The touch panel 30 may use, for sensing a touch, two methods that are a pressure sensor type for sensing pressure variance and an electrostatic capacity type for sensing electric signal caused by static electricity.

The audio output unit 42 includes a speaker. The unit 42 converts a call partner's audio signal received by the mobile phone 10 to sound and outputs the sound. The stereo speakers 48 also output a call sound, an operation sound of the input interface comprised of the first display unit 20 and the touch panel 30, TV sound, Music, an alarm sound etc.

The audio input unit 44 is made of a sound recognition device such as a microphone. It converts a voice of a user input during a call to electric signal which can be processed in the mobile phone 10.

The radio communication unit 102 executes wireless communication with the base station 200 by way of the mobile phone network. For such wireless communication protocol, there are TDMA (Time Division Multiple Access), CDMA (Code Division Multiple Access), OFDMA Orthogonal Frequency Division Multiplexing Access) etc.

### Action

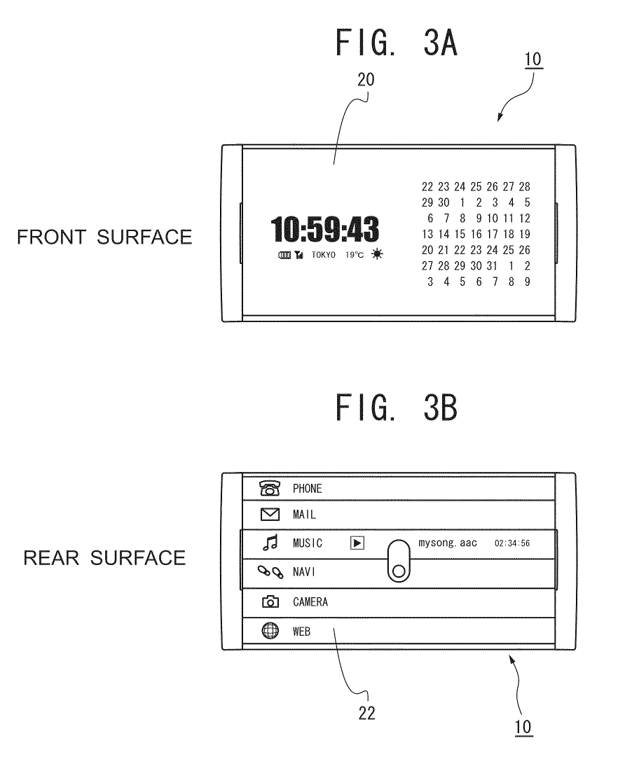

FIG. 3 is a view for illustrating exemplified of the first and second display units 20 and 22. As shown in FIG. 3A, on the first display unit 20 of the front surface of the mobile phone 10, an executing screen of a task being executed is displayed. As shown in FIG. 3B, on the second display unit 22 of the rear surface of the mobile phone 10, an other tasks' list screen is displayed. Those task-executing screen and list screen are displayed under control of the control unit 100.

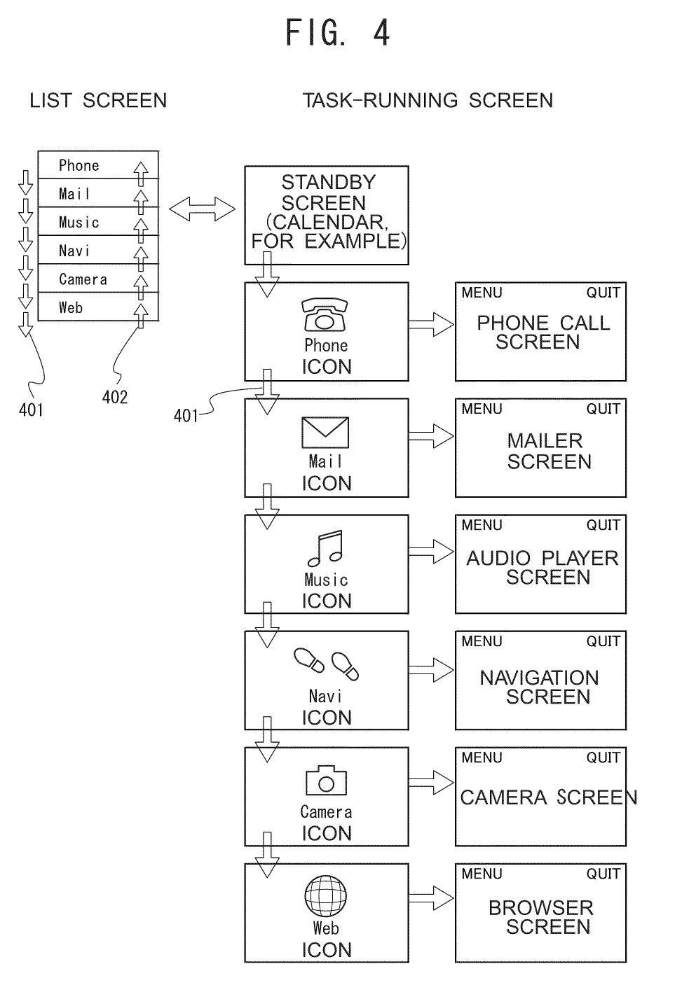

FIG. 4 is a view for illustrating the relationship between the task-executing screen of the first display unit 20 and the list screen of the second display unit 22. The task-executing screen of the first display unit 20 and the list screen of the second display unit 22 are linked with each other. On the first display unit 20, an executing screen of a task being executed is displayed. On the second display unit 22, a list screen of other tasks is displayed. When switching the application being executed (when switching the task-executing screen), the list screen on the second display unit 22 is scrolled.

For example, as shown in FIG. 4, suppose that the list screen lists tasks, PHONE, Mail, Music, Navi (GPS), Camera and Web in this order. When a user operates the mobile phone 10 to switch the task, the task is switched in the above-stated order.

That is to say, the control unit 100 scrolls a task displayed on the first display unit 20 in the scroll direction 401 to replace it with a new task which has been listed at the end of the scroll direction 402 in the list screen on the second display unit 22. The new task displayed on the first display unit 20 is simultaneously scrolled and removed from the list screen on the second display unit 22 in the scroll direction 402. On the other hand, the task which has been displayed on the first display unit 20 is scrolled in the scroll direction 401 and added to the list screen on the second display unit 22 at the other end of the scroll direction 402. An executing screen switch caused by a task switch is carried out by a continuous and smooth scroll display.

In this way, when a task listed in the list screen displayed on the second display unit 22 on the rear surface is turned around the mobile phone into the front surface, it is extendedly displayed on whole the first display unit 20. Accordingly, a number of tasks can be switched one by one by an operation like turning a cylinder around.

In the case that a new task has not yet been activated, an icon (virtual button) for activating the new task is displayed on the first display unit 20, instead of a task-executing screen. When the icon is tapped, the new task is activated. In the case that a new task has been activated, a current task-executing screen is displayed (not shown in the drawings).

As shown in the “Music” column of the list screen in FIG. 3B, when a task being executed is listed in the task list, a schematic status of the task may be displayed. In this way, even a status of a task not currently activated can be easily understood.

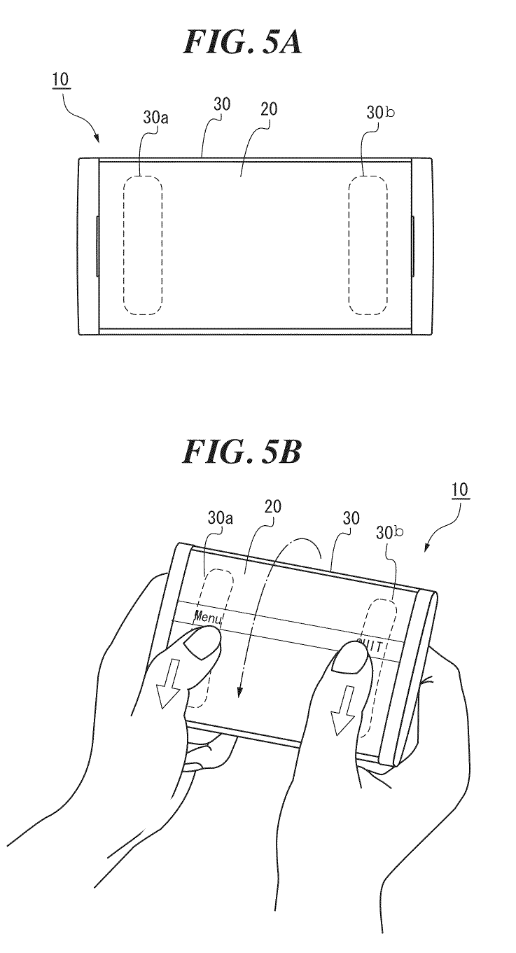

FIG. 5 is a view for illustrating an exemplified manner to input task-switching using the touch panel. The touch panel 30 is provided with a specific area. When rubbing the specific area, the control unit 100 carries out a task switching. The rubbing direction is the same as the scroll direction. Therefore, an intuitive operation is possible.

In the present embodiment, as shown in FIG. 5A, two task switch areas 30a and 30b are arranged near the both ends of the touch panel 30. As shown in FIG. 5B, the task switch areas are intended to be rubbed by thumbs of both hands. Since such two separate area to be rubbed are arranged, an operation mistake is prevented.

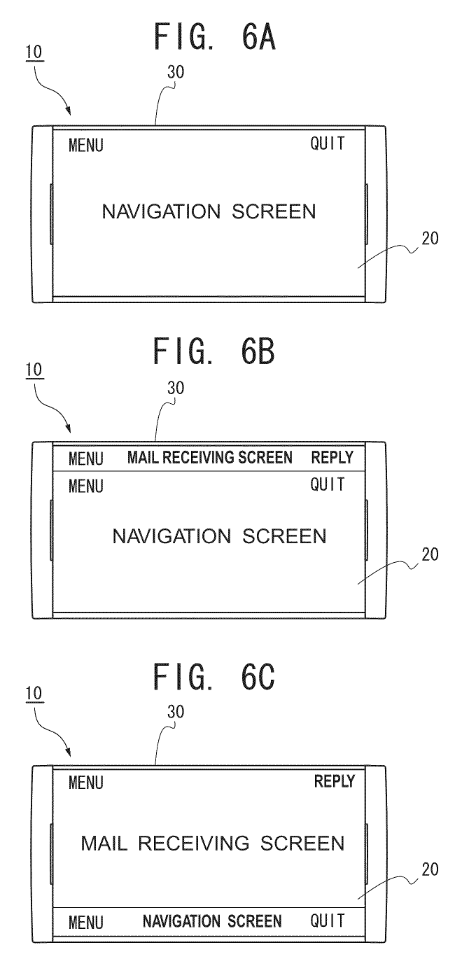

FIG. 6 is a view of an exemplified screen of the first display unit 20 displaying several task-executing screens. If the control unit 100 can execute several tasks at the same time (so-called multi-task), for example, as shown in FIG. 6A, when an email receives during Navigation (when Navi display is displayed), a mail receiving display is displayed. On this moment, as shown in FIG. 6B, a mainly executed task (Navi display) is displayed largely at the center of the first display unit 20 in the scroll direction. The other task (mail receiving display) is displayed at the upper or lower end of the first display unit 20 in the scroll direction by a schematic executing screen. When a user taps the mail receiving display, the schematic executing screen is extended to be a regular-sized mail receiving display and displayed as shown in FIG. 6C. Then, the Navi display is displayed at the lower end of the first display unit 20 in the scroll direction by a schematic executing screen.

As above, by displaying several task-executing screens on the first display unit 20, several tasks can be monitored at the same time. Therefore, task switching can be carried out easily without turning the task list until an objective one.

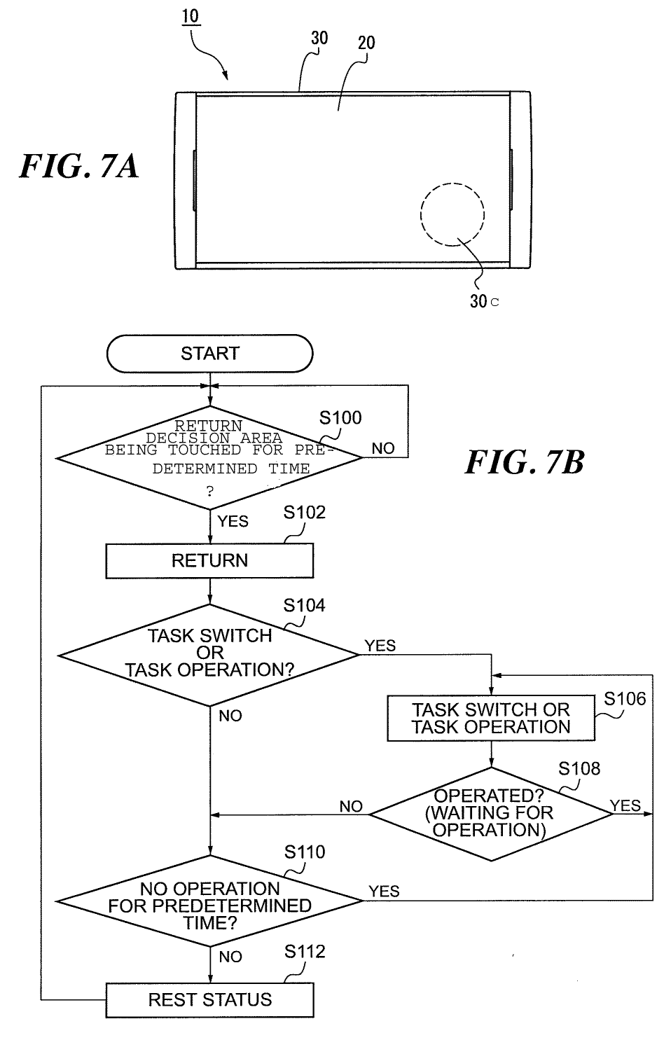

FIG. 7 is a view for an exemplified method for making a decision on whether or not return from the rest status should be carried out using the touch panel. FIG. 7A shows an example of return decision area. FIG. 7B shows a flowchart including steps of rest status and of return.

When no operation is sensed for a predetermined time, the control unit 100 enters into the rest status for stopping executing tasks except for some significant functions such as a communication function, in order to reduce power consumption and extend a working time of the mobile phone 10. When an operation to the mobile phone 10 is restarted, the control unit 100 returns from the rest status. However, the mobile phone 10 is operated by means of the touch panel 30 which is a device for detecting a tap. So, if the control unit 100 simply returns from the rest status when the touch panel 30 detects a tap, the control unit 100 can hardly enter the rest status and consumes power so much when the mobile phone 10 is for example in a bag or a pocket.

Accordingly, in the present embodiment, a specific input area is provided for making the control unit 100 return from the rest status. Specifically, as shown for example in FIG. 7A, a return decision area 30c is arranged at the lower right region of the touch panel 30. It is decided whether or not the return decision area 30c is touched for a predetermined time. In accordance with the decision, the control unit 100 returns from the rest status.

The rest status and return step of the control unit 100 is specifically explained with reference to the flowchart in FIG. 7B. At the beginning, on the assumption that the control unit 100 is currently in the rest status, the control unit 100 decides whether or not only the return decision area 30c is touched for a predetermined time (step S100). If it is decided that only the return decision area 30c is touched for the predetermined time, the control unit 100 returns (step S102). Then an input-waiting screen (screen of a task being executed) is displayed on the display unit, which is on the same surface as the return decision area 30c being touched, as the first display unit 20. On the other hand, a task list is displayed on the second display unit 22.

The control unit 100 decides, under the input-waiting screen, whether or not a task-switch is carried out, or whether or not an operation is carried out in a switched task (step S104). If an operation is carried out, the control unit 100 carries out a task switch (scrolling) or a task operation (step s106). After the step S106, the control unit 100 waits for an operation (step S108). If no operation is carried out after returning at the step S104, or if the control unit 100 waits for an operation at the step S108, it is decided whether or not no operation is carried out for a predetermined time (step S110). In the case that an operation is carried out, the task operation is carried out (step S106). In the case of no operation, the control unit 100 enters into the rest status (step S112). After entering into the rest status, the control unit 100 decides whether or not only the return decision area 30c is touched for a predetermined time again (step S100).

Because of the above-stated processes, even if the mobile phone 10 has a touch panel 30 on a whole surface of the housing, an operation mistake can be prevented very precisely. The control unit 100 may display, under the rest status, a still picture or a motion picture which indicates the scope of the return decision area 30c.

As explained above, the mobile phone 10 according to the present embodiment is provided, respectively on the opposite surfaces of the housing, with the first and second display units 20 and 22 which have almost the same display area. Therefore, the mobile phone 10 can increase the amount of information of the display units significantly. Beside, the mobile phone 10 can display a task-executing screen and a task list using the two display units and can switch the tasks by scrolling them together. So, various task-executing screens can be switched by an intuitive operation. The operability can be improved even for a recent mobile phone which is functionally advanced.

In the above embodiment, the list screen of the second display unit 22 only includes tasks other than that displayed on the first display unit 20. However, the present invention is not limited to the embodiment. The mobile phone may also display on the list screen an active task displayed on the first display unit 20. If the active task listed is displayed remarkably, it is possible to clearly recognize a current task being executed.

In the above embodiment, the power button 46 is arranged at the end of the end member 14. However, the end members 14 and 16 themselves may be power buttons with a switch structure. By enlarging the power button, the operability is improved. In addition, such a power button is apparently not remarkable so that it contributes the appearance of a mobile phone and secures an area for arranging connectors.

Besides, at the end of the end members 14 and 16, keys for character inputting may be arranged. For example, virtual keys for inputting consonants may be displayed on the touch panel 30, keys for inputting vowels may be arranged at the end member 14, and a decision key may be arranged on the end member 16. In this case, the area for each virtual key can be larger and therefore rapid inputting is possible.

### Other Embodiment

Another embodiment of the mobile phone according to the present invention is explained below. The structural elements which have essentially the same functional structure as those of the first embodiment are indicated by the same reference numerals in order to omit overlapping explanations.

In the first embodiment, a camera 40 is arranged on the rear surface (surface provided with the display unit 22) of the housing. However, almost all the front/rear surface of the housing is covered by the first or second display unit 20 or 22. Therefore the area for the display units are reduced because of the camera 40. As a result, the display capacity of the front/rear surfaces are not even. Besides, in the first embodiment, the touch panel 30 is overlapped only with the first display unit 20. It means that the front and rear surfaces of the housing of the mobile phone 10 are defined from the beginning.

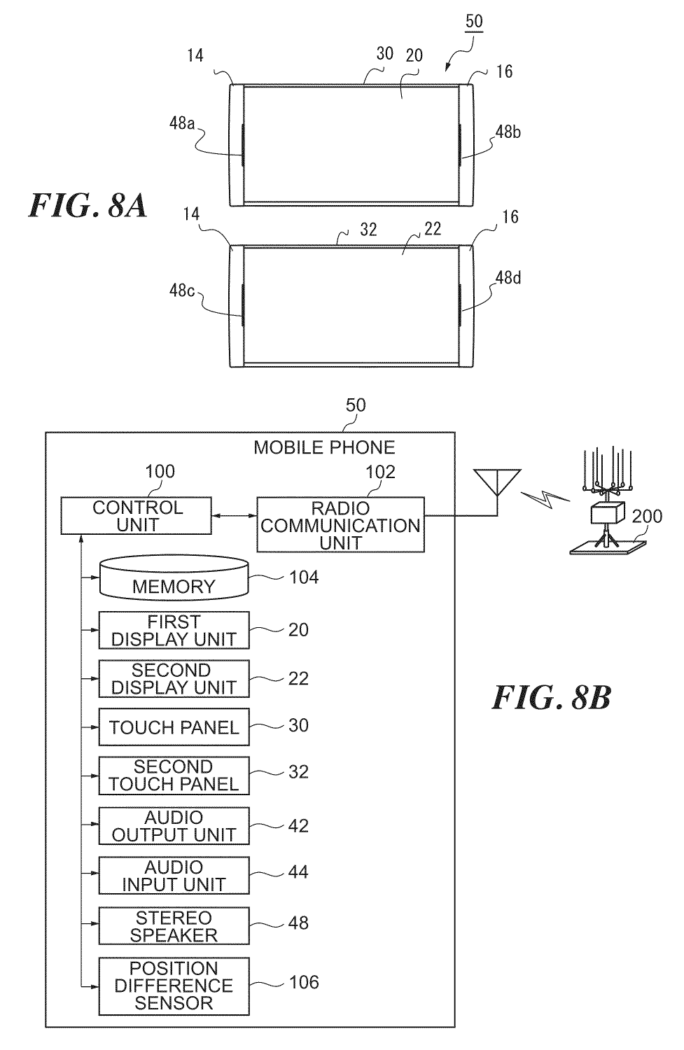

On the other hand, the mobile phone 50 shown in FIG. 8 has no distinction between the front/rear surfaces of the housing. FIG. 8A shows the appearance of the mobile phone 50 which is not provided with a camera 40, compared with the mobile phone 10. FIG. 8B is a block diagram for illustrating a schematic functions of the mobile phone 50. The mobile phone 50 is provided not only with the touch panel 30 overlapped with first display unit 20 but also with the second touch panel 32 overlapped with the second display unit 22. The mobile phone 50 is also provided with a position difference sensor 106 (3-dimensional accelerometer).

In this embodiment, there is no functional difference between the first and second display units 20 and 22 placed on the front and rear surfaces of the housing of the mobile phone 50. Therefore, it can be dynamically decided which display unit works as the first or second display unit 20 or 22.

So, for example, the control unit 100 may arrange return decision areas 30c for returning from the rest status (see FIG. 7A) on both surfaces of the housing. Then the control unit 100 may decide that the display unit on the same surface as one of the return decision areas 30c being touched for a predetermined time is the first display unit 20. In this way, it is possible to eliminate a distinction between the front and rear surfaces of the housing and therefore a surface which faces a user when the user grasps the housing can be always the front surface. So, the user does not need to change a front/rear position of the housing when he/she grasps it. This improves the operability.

Because the position difference sensor 106 arranged in the housing can detect the gravity direction, the control unit 100 can decide that one display unit arranged on the surface directed upward is the first display unit 20 on which screens of a task being executed are displayed, and that the other display unit arranged on the surface directed downward is the second display unit 22 on which a task list is displayed. Even in the case of this embodiment, it is preferable to decide the above matters when returning from the rest status.

Instead of eliminating the camera 40 as the mobile phone 50, the same cameras 40 may be arranged both surfaces of the mobile phone 10. If using the cameras arranged on the both surfaces of the housing as illumination sensors, the control unit 100 may decide that one display unit positioned on a surface of higher illuminance is the first display unit 20 on which screens of a task being executed are displayed, and that the other display unit placed on a surface of lower illuminance is the second display unit 22 on which a task list is displayed.

The control unit 100 may not accept an input from the second touch panel 32 overlapped with the second display unit 22, when one of the two display units is decided to be the first display unit 20 (display unit on which screens of a task being executed are displayed). This prevents an operation mistake caused by an input by a hand, since the housing is supposed to be supported by a hand on the backside during task operation. When entering into the rest status again, the touch panel 30 and the second touch panel 32 on both surfaces of the housing are valid. In this way, when returning from the rest status next time, front/rear surfaces of the housing can be decided freely.

The position difference sensor 106 can detect that the mobile phone 50 is shaken. This can be used for an operation input for a main task. More specifically, for example, by shaking the housing, it is possible to turn a page of an electronic novel or comic. Particularly, by turning the mobile phone 50 over and over again, it is possible to display following pages one by one on display units on the front and rear surfaces. According to this operation, a new operability can be proposed such that pages are turned over as if a scroll is unrolled.

As above, by providing display units and touch panels arranged on all the surfaces of the housing, various new applications (tasks) we have ever had can be proposed. For example, it is possible to propose a new application of a virtual water tank displayed wherein goldfishes are swimming. When a goldfish is picked, it escapes into the rear surface. If using the advantage that the front and rear surfaces cannot be monitored at the same time, a poker game or a competition game can be carried out. For example, if using the advantage that the display unit of the rear surface faces toward a partner during an operation on the front surface, it is possible to display on the second display unit 22 a QR code to be read by the partner's apparatus.

Although the present invention has been described with reference to the preferred embodiments while referring to the accompanying drawings, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

For example, in the above embodiments, the first and second display units 20 and 22 are described as curved along their contours and connected to each other. However, flat first and second display units 20 and 22 can be also used. In that case, the visual continuity of a task-executing screen and a list screen is spoiled, but it is possible to obtain the other advantages of the present invention such as an improved operability suitable for multi functions etc.

The above embodiments are described such that they have functions of Phone, Mail, Music, Navigation (GPS) Camera, Web etc (see FIG. 4). However, they may have only a part of those functions and may have functions (scheduler function, for example) other than the above ones.

Although a mobile phone is described as the embodiments of an electronic apparatus according to the present invention as above, the invention can be applied in addition to a mobile phone to a PDA, computer, digital camera, audio player car navigation system, television, game machine, DVD player and remote controller.

### INDUSTRIAL APPLICATION OF THE INVENTION

The present invention can be applied to an electronic apparatus which displays a task-executing screen using a display unit.

1. An electronic apparatus comprising:
a first display unit placed on one surface of a housing;
a second display unit placed on the other surface opposite to said first display unit and provided with approximately the same display area as that of said first display unit;
a touch panel overlapped at least with one of said first and second display units;
a control unit for executing tasks, displaying images on said first or second display unit and receiving input from said touch panel.

2. The electronic apparatus according to claim 1, wherein contours of said first and second display units are curved and connected to each other in order to surround the periphery of the housing.

3. The electronic apparatus according to claim 2, wherein the contour of the housing has an approximate elliptic form including said curved first and second display units.

4. The electronic apparatus according to claim 1, wherein said control unit displays on said first display unit a screen of a task being executed, and displays on said second display unit a list screen of other tasks.

5. The electronic apparatus according to claim 1, wherein said control unit displays on said first display unit a screen of a task being executed, and displays on said second display unit a list screen of several tasks including the task being executed.

6. The electronic apparatus according to claim 5, wherein said control unit senses that a specific area of said touch panel is rubbed, replaces a task displayed on said first display unit with another new task which has been listed at the other end of the rubbing direction in the list screen on said second display unit, removes the new task displayed on said first display unit from the list screen on said second display unit, and adds the task which has been displayed on said first display unit to the list screen on said second display unit at the end of the rubbing direction.

7. The electronic apparatus according to claim 6, wherein said control unit carries out an executing screen switch caused by the task switch by a continuous scroll display.

8. The electronic apparatus according to claim 6, wherein said control unit can execute several tasks at the same time, displays executing screens of the executed several tasks on said first display unit so that an executing screen of a mainly executed task is displayed at the center in the rubbing direction and schematic executing screens of the other tasks are displayed at the upper or lower end in the rubbing direction.

9. The electronic apparatus according to claim 1, wherein said control unit enters into the rest status for stopping executing tasks except for predetermined tasks when no input from said touch panel is sensed for a predetermined time, returns from the rest status when it is sensed that a specific area of said touch panel overlapped respectively with said first and second display units is touched for a predetermined time, and displays a screen of a task being executed on the display unit which is on the same surface as the specific area being touched.

10. The electronic apparatus according to claim 1, further comprising illumination sensors arranged on the both surfaces on which said first and second display units are respectively placed,
wherein said control unit compares outputs from said illumination sensors and displays a screen of a task being executed on one of said display units placed on the surface from which a lighter illuminance is sensed.

11. The electronic apparatus according to claim 1, further comprising a position difference sensor for sensing a position of the housing,
wherein said control unit displays a screen of a task being executed on one of said first and second display units, based on a sensing result of said position difference sensor.

12. The electronic apparatus according claim 9, wherein said control unit accepts an input from one touch panel overlapped with one of said first and second display units on which a screen of a task being executed is displayed, and does not accept an input from the other touch panel overlapped with the other one of said display units.

13. The electronic apparatus according to claim 1, further comprising:
an audio input unit arranged at one side of the housing; and
an audio output unit arranged on the other side of the housing opposite to the one side on which said audio input unit is arranged.

14. The electronic apparatus according claim 10, wherein said control unit accepts an input from one touch panel overlapped with one of said first and second display units on which a screen of a task being executed is displayed, and does not accept an input from the other touch panel overlapped with the other one of said display units.

15. The electronic apparatus according claim 11, wherein said control unit accepts an input from one touch panel overlapped with one of said first and second display units on which a screen of a task being executed is displayed, and does not accept an input from the other touch panel overlapped with the other one of said display units.
